(19) United States
(12) Patent Application Publication
(10) Pub. No.: US 2002/0082746 A1
(43) Pub. Date: Jun. 27, 2002

(54) Replaceable media with programmable device

(75) Inventors: Thomas J. Schubring, Stillwater, MN (US); Peter J. McKinney, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 09/749,102

(22) Filed: Dec. 27, 2000

(51) Int. Cl. G05B 15/00

(52) U.S. Cl. 700/275; 700/276

(57) ABSTRACT

Methods and apparatus for providing a software upgrade are disclosed. A replaceable media assembly in accordance with the present invention includes a replaceable media component, and an information storage device fixed to the replaceable media component. An interconnect is coupled to the information storage device for electrically connecting the information storage device to the controller of a system that receives the replaceable media assembly.

### FIELD OF THE INVENTION

The present invention relates generally to systems that use replaceable media, and more specifically, to replaceable media that include a micro-controller or a storage device.

### BACKGROUND OF THE INVENTION

Nearly every consumer living in an industrialized nation makes use of a system that uses replaceable media. For example, many heating, ventilation, and air conditioning (HVAC) systems for homes and buildings use one or more filters that must be periodically replaced. Similarly, most braking system used in vehicles have brake pads and/or brake shoes that must be periodically replaced.

A difficulty with many such systems is that the user or operator of the system must periodically inspect and/or replace the replaceable media. Because the users of such system often do not take the time to periodically inspect the replaceable media, the manufacturer of such systems often provide maintenance schedules. For many home HVAC systems, for example, the manufacturer often specifies that the filter should be replaced every three months. Likewise, for automobiles, the manufacturer often specifies that the brake pads should be replaced every 30,000 miles, or the oil filter should be replaced every 3,000 miles.

A limitation of rigid maintenance schedules is that the actual condition of the replaceable media at the end of the maintenance period is dependent on the environment or use of the system, and the quality of the replaceable media itself. For example, the actual condition of the filter used in a home HVAC system at the end of a suggested maintenance period will depend on the condition or use of the house, and on the quality and/or performance characteristics of the particular filter used. Similarly, the actual condition of the brake pads on a vehicle at the end of a suggested maintenance period will depend on the driving habits of the driver, and the quality and/or performance characteristics of the particular brake pads used.

There are often many manufacturers that provide replaceable media for various systems. The quality and performance characteristics of the replaceable media can vary between manufacturers, and between targeted price points. Accordingly, the quality and performance of the replaceable media is usually difficult to predict in advance. This is particularly problematic when the quality and performance characteristics of the replaceable media effects the operation or performance of the overall system.

Many systems that use replaceable media also have a controller for controlling at least part of the operation of the system. Most controllers used in such systems are programmable, that is, they have a memory for storing a program that controls the operation of the controller. In some circumstances, it would be desirable to replace or upgrade the program in the memory of the controller. For example, if a manufacturer of a system identifies new ways to improve the performance of the system through a software upgrade, or identifies one or more bugs in the original software, it may be desirable to replace or upgrade the program in the memory of the controller.

Providing a program upgrade to a system in the field can be difficult and expensive. One method is to have a technician visit the location (e.g., home, factory, etc.) where the system is used, and install a new program in the memory of the system. This, however, requires paying for the time and travel expenses of the technician. Another method is to ship the system back to the factory for upgrading. However, this is usually prohibitively expensive, and may require that the system to be down for an extended period of time.

### SUMMARY OF THE INVENTION

The present invention overcomes many of the disadvantages of the prior art by providing a replaceable media assembly for use in a system, wherein the replaceable media assembly includes a controller or storage element that can communicate with the system. Providing a controller or storage element in conjunction with a replaceable media element can provide a number of advantages. For example, when the controller or storage element stores information about the replaceable media, this information can be passed to the system. The system may then identify the replaceable media, identify the performance characteristics of the replaceable media, and/or optimize the performance of the system based on the performance characteristics of the replaceable media. Alternatively, or in addition, the system may receive software upgrades from the controller or storage element of the replaceable media assembly.

One illustrative embodiment of a replaceable media assembly is adapted for use with a heating, ventilation, and air conditioning (HVAC) system. The HVAC system may include a filter housing disposed in fluid communication with a blower. The filter housing may include a plurality of walls defining a chamber. In a preferred embodiment, the filter housing is adapted to receive a replaceable media assembly. In a preferred embodiment, the replaceable media assembly includes an air filter, and the blower is selectively actuated to force air through the filter housing and through the air filter.

Information is preferably stored in an information storage device, which is fixed to the replaceable media assembly. The information stored in the information storage device may be used by the controller of the system to adjust the operation of the system. For example, the information stored in the information storage device may relate to the performance characteristics of the replaceable media component of the replaceable media assembly. In the present example, the information stored in the information storage device may include a pressure drop value. The pressure drop value may be, for example, the expected pressure drop through the air filter when the air filter is clean. The controller of the system may read the expected pressure drop value and adjust the operation of the blower of the system to accommodate the pressure drop.

The information stored in the information storage device may also include an expected pressure drop value that relates to the expected pressure drop through the air filter when the air filter is dirty. The controller of the system may read the expected pressure drop value from the information storage device and compare that pressure drop to a current pressure drop measured using a differential pressure sensor coupled to the controller. When the measured pressure drop exceeds the pressure drop expected from a dirty filter, the controller of the system may provide a notification to exchange the replaceable media assembly with a new replaceable media assembly.

The information stored in the information storage device may also include a time value that relates to the recommended replacement interval of the replaceable media assembly. When the system receives a replaceable media assembly, the controller may read a serial number stored in the information storage device of the replaceable media assembly. The controller may begin tracking the length of time that the replaceable media assembly is in use. When the replacement interval is reached, the controller of system may provide a notification to exchange replaceable media assembly with a new replaceable media assembly.

The controller or information storage device, which is fixed to the replaceable media assembly, may also contain information about the characteristic pressure drop curve for the particular media material. This information can be used by the controller to determine the proper pressure drop set points for media replacement, controlling the rate of flow in a filter system, controlling the rate of application in an automatic braking system, and determining at what flow rate an active filter system should be turned on.

The controller or information storage device, which is fixed to the replaceable media assembly, may also contain information about the characteristic pressure drop curve that could be customized for the particular batch of media or for more unstable media. The pressure drop curve could be determined for each device by testing at the time of manufacture and storing that information in the controller or storage device prior to shipment. These methods might be particularly useful on high cost replaceable media such as clean room HEPPA filters. In some embodiments, the controller or information storing device may be the only controller in the system.

The information stored in the information storage device may also include a model number of the replaceable media assembly. The controller of the system may read the model number from the information storage device and determine the compatibility of the replaceable media assembly with the system. The controller of the system may provide a notification if the replaceable media assembly is not compatible with the system.

### BRIEF DESCRIPTION OF THE DRAWINGS

FIG. 1 is a block diagram of a system in accordance with an exemplary embodiment the present invention;

FIG. 2 is a block diagram of an additional exemplary embodiment of a system in accordance with the present invention;

FIG. 3 is a perspective view of a replaceable media assembly in accordance with the present invention;

FIG. 4 is a partial cross sectional view of a filter housing of a system in accordance with an exemplary embodiment of the present invention; and

FIG. 5 is a diagrammatic depiction of a vehicle having a plurality of the wheels and a braking system for slowing and/or stopping the rotation of the wheels.

### DETAILED DESCRIPTION OF THE INVENTION

The following detailed description should be read with reference to the drawings, in which like elements in different drawings are numbered in like fashion. The drawings, which are not necessarily to scale, depict selected embodiments and are not intended to limit the scope of the invention. In some cases, the drawings may be highly diagrammatic in nature. Examples of constructions, materials, dimensions, and manufacturing processes are provided for various elements. Those skilled in the art will recognize that many of the examples provided have suitable alternatives which may be utilized.

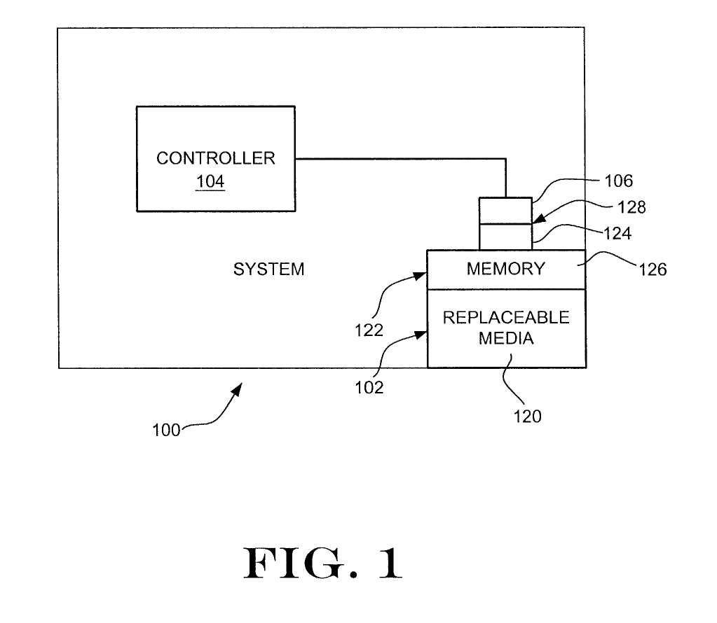

FIG. 1 is a block diagram of a system 100 in accordance with an illustrative embodiment the present invention. The system 100 is preferably adapted to receive a replaceable media assembly 102. The system 100 includes a controller 104 and a controller interconnect 106 which is coupled to the controller 104. The replaceable media assembly 102 includes a replaceable media component 120, an information storage device 122, and a storage device interconnect 124 which is coupled to the information storage device 122. In the embodiment of FIG. 1, the information storage device 122 includes a memory 126. The storage device interconnect 124 is preferably adapted to releasably mate with the controller interconnect 106 of the system 100 to form a connection 128. The storage device interconnect 124 and the controller interconnect 106 may each include a plurality of contacts.

Alternatively, it is contemplated that the storage device interconnect 124 and the controller interconnect 106 may include a wireless connection, such as an RF connection. This may eliminate the need for mechanical connectors. In one embodiment, the storage device interconnect 124 may be a transponder, which receives power from a query signal provided by the controller interconnect 106, and sends the information back to the controller interconnect 106.

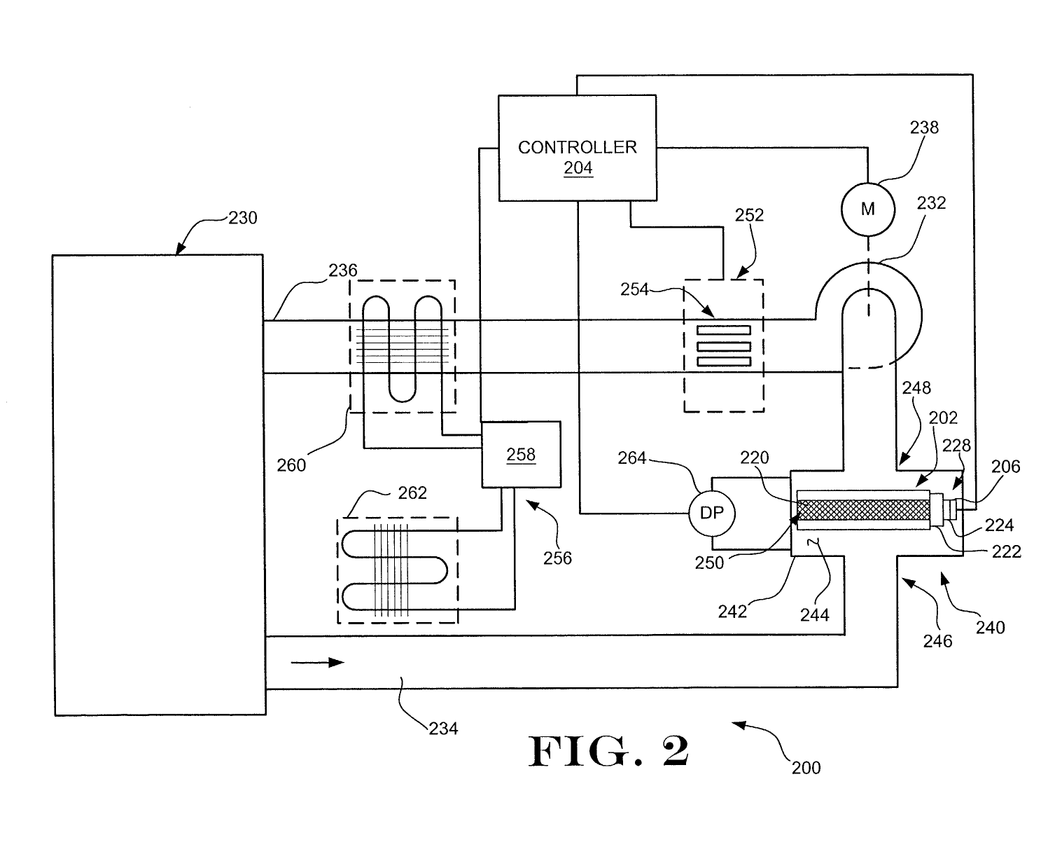

FIG. 2 is a block diagram of an additional exemplary embodiment of a system 200 in accordance with the present invention. The system 200 of FIG. 2 may be generally referred to as a heating, ventilation, and air conditioning (HVAC) system. The system 200 is preferably adapted to control the temperature of the air within an inside space 230.

In the illustrative embodiment of FIG. 2, the system 200 includes a motor 238 that is coupled to a blower 232. The blower 232 is in fluid communication with a first duct 234 and a second duct 236. The blower 232 may be used to draw air from the inside space 230 through the first duct 234 and return air to the inside space 230 via second duct 236. The motor 238 may be selectively activated by a controller 204 which is coupled to the motor 238.

A filter housing 240 is disposed in fluid communication with the blower 232 and the inside space 230. The filter housing 240 includes a plurality of the walls 242 defining a chamber 244. The filter housing 240 also includes an inlet 246 and an outlet 248 in fluid communication with the chamber 244. In a preferred embodiment, the filter housing 240 of the system 200 is adapted to receive a replaceable media assembly 202. In the embodiment of FIG. 2, the replaceable media assembly 202 is disposed within the chamber 244 between inlet 246 and outlet 248.

The replaceable media assembly 202 includes a replaceable media component 220, which in the embodiment shown, is an air filter 250. The replaceable media assembly 202 also includes an information storage device 222, and a storage device interconnect 224 which is coupled to the information storage device 222. The storage device interconnect 224 is preferably adapted to releasably mate with a controller interconnect 206 of the system 200 to form a connection 228. The storage device interconnect 224 and the controller interconnect 206 may each include a plurality of contacts.

The system 200 also includes a furnace 252 having a heat exchanger 254 that is in fluid communication with the blower 232 and the inside space 230. The furnace 252 may be used to heat an air stream passing through the heat exchanger 254 and into the inside space 230. The system 200 of FIG. 2 also includes an air conditioner 256 having a compressor 258, a condenser 262 and an evaporator 260. The evaporator 260 may be used to cool an air stream passing through the evaporator 260 and into the inside space 230. In the embodiment of FIG. 2, the furnace 252 and the air conditioner 256 are both coupled to the controller 204. The controller 204 may be used to control the temperature of the air in the inside space by selectively activating the furnace 252 and the air conditioner 256.

Information is preferably stored in the information storage device 222 of the replaceable media assembly 202. The information stored in the information storage device 222 may be used by the controller 204 to adjust the operation of the system 200. For example, the information stored in the information storage device 222 may relate to the performance characteristics of the replaceable media component 220 of the replaceable media assembly 202. In this example, the information stored in the information storage device 222 may include a pressure drop value. The pressure drop value may be, for example, the expected pressure drop through the air filter 250 when the filter is clean. The controller 204 of the system 200 may read the expected pressure drop value and adjust the operation of the blower 232 of the system 200 to accommodate the pressure drop.

The information stored in the information storage device 222 may also include an expected pressure drop value that relates to the expected pressure drop through the air filter 250 when the filter is dirty. The controller 204 of the system 200 may read the expected pressure drop value from the information storage device 222 and compare that pressure drop to a current pressure drop measured using a differential pressure sensor 264 coupled to the controller 204. When the measured pressure drop exceeds the pressure drop expected from a dirty filter, the controller 204 of the system 200 may provide a notification to exchange the replaceable media assembly 202 with a new replaceable media assembly. The notification may be, for example, an audible signal and/or a visual signal.

The information stored in the information storage device 222 may also include a time value that relates to a recommended replacement interval that is associated with the replaceable media component 220 of the replaceable media assembly 202. When the system 200 receives a replaceable media assembly 202, the controller 204 may read a serial number stored in the information storage device 222 of the replaceable media assembly 202. The controller 204 may begin tracking the length of time that the replaceable media assembly 202 is in use. When the replacement interval is reached, the controller 204 of the system 200 may provide a notification to exchange the replaceable media assembly 202 with a new replaceable media assembly. The notification may be, for example, an audible signal and/or a visual signal.

In yet another example, the information storage device 222 may include a programmed micro-controller and the information stored in the information storage device 222 may include a program. The program may cause the micro-controller to communicate with the controller 204 of the system 200. The program may also cause the micro-controller to pass a number of performance parameters related to the replaceable media to the controller of the system. In some embodiments, the program may also cause the micro-controller to provide a software upgrade to the controller 204 of the system 200.

It is contemplated that the information stored in the information storage device 222 may include a model number of the replaceable media assembly 202. The controller 204 of the system 200 may read the model number from the information storage device 222 and determine the compatibility of the replaceable media assembly 202 with the system 200. The controller 204 of the system 200 may provide a notification if the replaceable media assembly 202 is not compatible with the system 200. The notification may be, for example, an audible signal and/or a visual signal.

The information stored in the information storage device 222 may also include additional information without deviating from the spirit and scope of the present invention. Examples of additional information include sound files, graphics files, advertisement files, and user instruction sets.

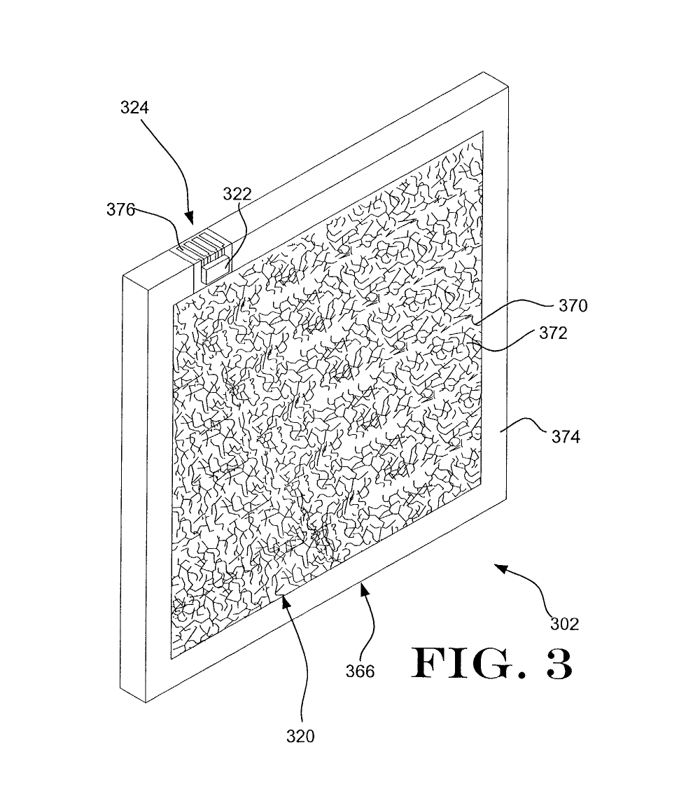

FIG. 3 is a perspective view of a replaceable media assembly 302 in accordance with the present invention. The replaceable media assembly 302 includes a replaceable media component 320 and a carrier 366 for carrying the replaceable media component 320. In the embodiment of FIG. 3, the replaceable media component 320 is a filter that has a plurality of the fibrils 370 arranged in a substantially randomly intertangled pattern. The fibrils 370 define a plurality of the air flow pathways 372 which are substantially tortuous. It is to be understood that other embodiments of the replaceable media component 320 are possible without deviating from the spirit and scope of the present invention.

In the embodiment of FIG. 3, the carrier 366 includes a frame 374 that surrounds the outer edges of the replaceable media component 320. An information storage device 322 is fixed to the carrier 366. The information storage device 322 is coupled to a storage device interconnect 324 which is preferably adapted to form a connection with the controller of a system. In FIG. 3, it may be appreciated that the storage device interconnect 324 includes a plurality of contacts 376.

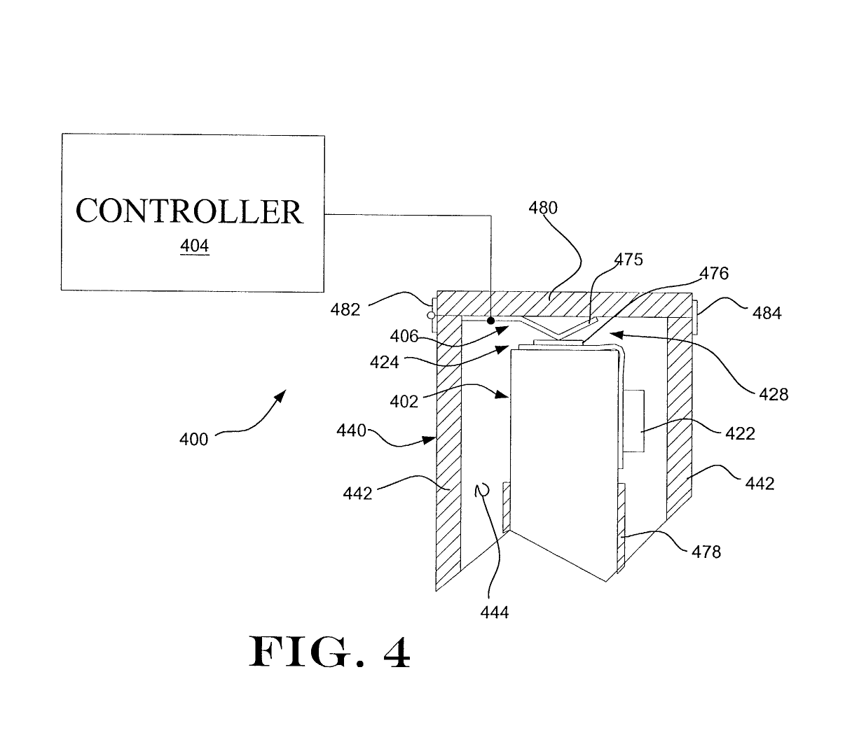

FIG. 4 is a partial cross sectional view of a filter housing 440 of a system 400 in accordance with an illustrative embodiment of the present invention. The filter housing 440 includes a plurality of the walls 442 defining a chamber 444. In a preferred embodiment, the filter housing 440 of the system 400 is adapted to receive a replaceable media assembly 402. The replaceable media assembly 402 is disposed within the chamber 444 between walls 442. The position of the replaceable media assembly 402 within the chamber 444 is maintained by a plurality of positioning flanges 478. The replaceable media assembly 402 includes an information storage device 422, and a storage device interconnect 424 that is coupled to the information storage device 422.

The filter housing 440 also includes a door 480 that is coupled to a wall 442 of the filter housing 440 by a hinge or latching system 482. In the embodiment of FIG. 4, the door 480 is in a closed position, but the door 480 may be selectively placed in an open position. In the embodiment of FIG. 4, the door 480 is held in the closed position by a latch 484.

When the door 480 is in the closed position, the storage device interconnect 424 preferably releasably mates with a controller interconnect 406 to form a connection 428. The controller interconnect 406 is coupled to a controller 404 of the system 400. As shown in FIG. 4, a plurality of contacts 476 of the storage device interconnect 424 are coupled to a plurality of contacts 475 of the controller interconnect 406.

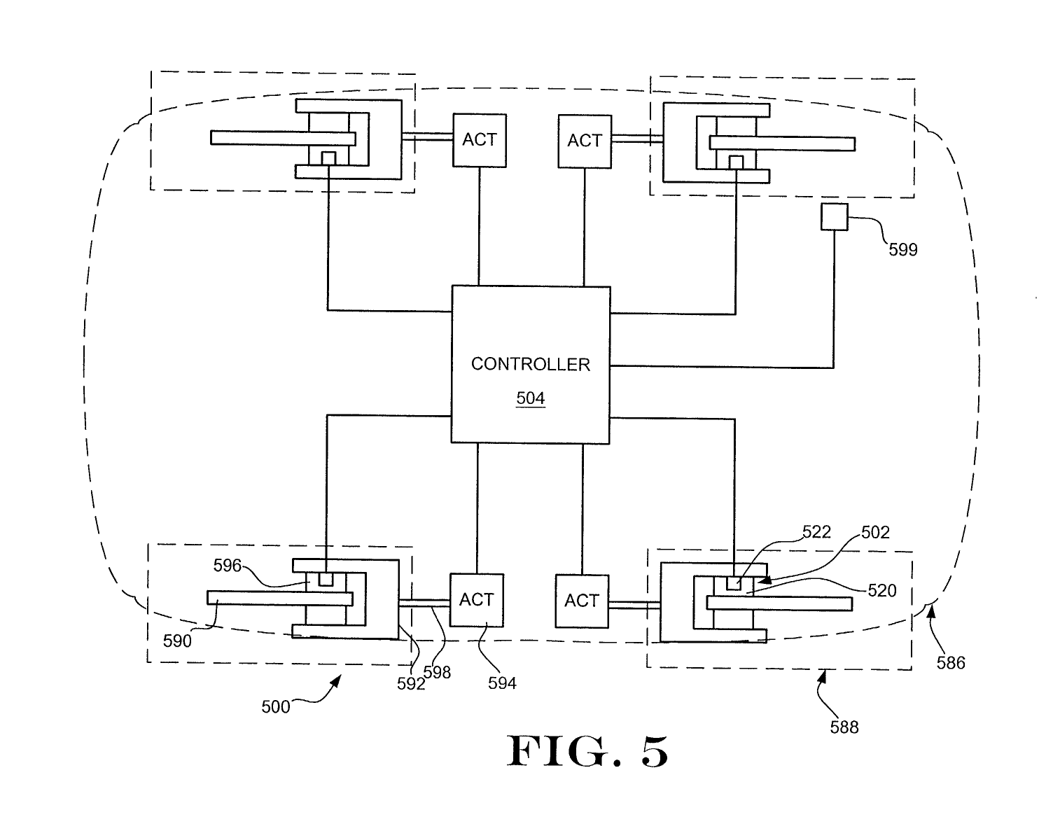

FIG. 5 is a diagrammatic depiction of a vehicle 586 having a plurality of the wheels 588 and a braking system 500 for slowing and/or stopping the rotation of the wheels 588. The braking system 500 includes a brake rotor 590 coupled to each wheel 588. A brake caliper 592 is disposed proximate each brake rotor 590. Each brake caliper 592 of the braking system 500 is preferably adapted to receive a replaceable media assembly 502. Each replaceable media assembly 502 includes a replaceable media component 520 and an information storage device 522. In the embodiment of FIG. 5, each replaceable media component 520 includes a brake pad 596.

The braking system 500 of FIG. 5 also includes a controller 504 that is coupled to the information storage device 522 of each replaceable media assembly 502. The controller 504 is also coupled to a plurality of the brake actuators 594. Each brake actuator 594 is coupled to a brake caliper 592 by a hydraulic conduit 598. In a preferred embodiment, the controller 504 may selectively activate each brake actuator 594. When a brake actuator 594 is activated, it applies pressure to a cylinder of a brake caliper 592 via hydraulic fluid disposed within the hydraulic conduit 598. When pressure is applied to the brake caliper 592, the brake rotor 590 disposed proximate the brake caliper 592 will be squeezed between two brake pads 596. Each brake actuator 594 may be supplied with pressurized hydraulic fluid by a master cylinder (not shown).

Information is preferably stored in the information storage device 522 of each replaceable media assembly 502. The information stored in the information storage device 522 may be used by the controller 504 of the braking system 500 to adjust the operation of the braking system 500. For example, the information stored in the information storage device 522 may relate to the performance characteristics of the brake pad 596 of each replaceable media assembly 502.

The information stored in the information storage device 522 may also include a time value that relates to the recommended replacement interval of the replaceable media assembly 502. When the system 500 receives a replaceable media assembly 502, the controller 504 may read a serial number stored in the information storage device 522 of the replaceable media assembly 502. The controller 504 may begin tracking the length of time that the replaceable media assembly 502 is in use. When the replacement interval is reached, the controller 504 of the system 500 may provide a notification to exchange the replaceable media assembly 502 with a new replaceable media assembly. The notification may be, for example, an audible signal and/or a visual signal.

The manufacturer of the vehicle 586 may also recommend that the brake pads 596 be replaced at a certain mileage interval. When this is the case, the information stored in the information storage device 522 may include a distance value that relates to a recommended replacement interval for the brake pads 596 of the replaceable media assembly 502. The controller 504 of the system 500 may read the distance value traveled by the vehicle 586 via a wheel rotation sensor 599. The controller may track the distance that the vehicle 586 travels after the installation of a replaceable media assembly 502 having a particular serial number stored in the information storage device 522 thereof. When the distance traveled exceeds the distance value stored in the information storage device 522, the braking system 500 may signal a user of the vehicle 586 that each replaceable media assembly 502 including the brake pad 596 should be replaced.

Having thus described the preferred embodiments of the present invention, those of skill in the art will readily appreciate that yet other embodiments may be made and used within the scope of the claims hereto attached. Numerous advantages of the invention covered by this document have been set forth in the foregoing description. It will be understood, however, that this disclosure is, in many respects, only illustrative. Changes may be made in details, particularly in matters of shape, size, and arrangement of parts without exceeding the scope of the invention. The invention's scope is, of course, defined in the language in which the appended claims are expressed.

What is claimed is:

1. A replaceable media assembly for use with a system that receives the replaceable media, the system having a controller, the replaceable media assembly comprising:
replaceable media;
storage means for storing information, said storage means fixed to the replaceable media; and
communication means for providing communication between the storage means and the controller of the system.

2. The replaceable media assembly of claim 1, wherein the information stored in the storage means is used by the controller of the system to adjust the operation of the system.

3. A replaceable media assembly according to claim 1, wherein the information stored in the storage means relates to the replaceable media.

4. A replaceable media assembly according to claim 1, wherein the information stored in the storage means relates to the performance of the replaceable media.

5. The replaceable media assembly of claim 1, wherein the storage means comprises a memory.

6. The replaceable media assembly of claim 1, wherein the storage means comprises a programmed micro controller.

7. The replaceable media assembly of claim 1, wherein the information stored in the storage means includes a time value that relates to the recommended replacement interval of the replaceable media assembly.

8. The replaceable media assembly of claim 1, wherein the replaceable media comprises a brake pad.

9. The assembly of claim 1, wherein the replaceable media comprises a filter.

10. The replaceable media assembly of claim 9, wherein information stored in the storage means includes an expected pressure drop value that relates to the expected pressure drop through the replaceable media when the replaceable media is clean.

11. The replaceable media assembly of claim 10, wherein the controller of the system reads the expected pressure drop value and adjusts the operation of the system to accommodate the pressure drop.

12. The replaceable media assembly of claim 9, wherein information stored in the storage means includes a maximum pressure drop value that relates to the expected pressure drop through the replaceable media when the replaceable media is dirty.

13. The replaceable media assembly of claim 12, wherein the controller of the system reads the maximum pressure drop value and provides a notification to change the filter when the system detects that the maximum pressure drop value is reached.

14. The replaceable media assembly of claim 1, wherein the storage means comprises a programmed micro-controller and the information stored in the storage means comprises a program.

15. The replaceable media assembly of claim 14, wherein the program causes the micro-controller to communicate with the controller of the system.

16. The replaceable media assembly of claim 15, wherein the program causes the micro-controller to pass a number of performance parameters related to the replaceable media to the controller of the system.

17. The replaceable media assembly of claim 15, wherein the program causes the micro-controller to provide a software upgrade to the controller of the system.

18. The replaceable media assembly of claim 1, wherein the information stored in the storage means includes a serial number or model number of the replaceable media.

19. The replaceable media assembly of claim 18, wherein the controller of the system reads the serial number or model number from the storage means and determines the compatibility of the replaceable media with the system.

20. The replaceable media assembly of claim 1, wherein the information stored in the storage means includes one of the following: a performance parameter, a serial or model number, a sound file, a graphics file, an advertisement file, or a user instruction set.

21. A replaceable filter assembly for use with an HVAC system that receives the replaceable media, the HVAC system having a controller, the replaceable filter assembly comprising:
a filter material;
a carrier for carrying the filter material;
storage means for storing information, said storage means fixed to the carrier; and
electrical connecting means for electrically connecting the storage means to the controller of the HVAC system when the replaceable filter assembly is received by the HVAC system.

22. The replaceable filter assembly of claim 21, wherein the information stored in the storage means is used by the controller of the HVAC system to adjust the operation of the HVAC system.

23. The replaceable filter assembly of claim 21, wherein the storage means comprises a memory.

24. The replaceable filter assembly of claim 21, wherein the storage means comprises a programmed micro controller.

25. The replaceable filter assembly of claim 21, wherein the information stored in the storage means includes a time value that relates to the recommended replacement interval of the replaceable filter assembly.

26. The replaceable filter assembly of claim 21, wherein information stored in the storage means includes a maximum pressure drop value that relates to the expected pressure drop through the replaceable media when the replaceable media is dirty.

27. The replaceable filter assembly of claim 26, wherein the controller of the HVAC system reads a present pressure drop value from a pressure sensor and provides a notification to change the filter when the HVAC system detects that the present pressure drop value is greater than maximum pressure drop value.

28. The replaceable filter assembly of claim 21, wherein the storage means comprises a programmed micro-controller and the information stored in the storage means comprises a program.

29. The replaceable filter assembly of claim 28, wherein the program causes the micro-controller to communicate with the controller of the HVAC system.

30. The replaceable filter assembly of claim 29, wherein program causes the micro-controller to pass a number of performance parameters related to the replaceable media to the controller of the HVAC system.

31. The replaceable filter assembly of claim 29, wherein the program causes the micro-controller to provide a software upgrade to the controller of the HVAC system.

32. The replaceable filter assembly of claim 21, wherein the information stored in the storage means includes a model number of the replaceable filter assembly.

33. The replaceable filter assembly of claim 32, wherein the controller of the HVAC system reads the model number from the storage means and determines the compatibility of the replaceable media with the HVAC system.

34. The replaceable filter assembly of claim 33, wherein the controller of the HVAC system provides notification, to a user of the HVAC system if the replaceable media is not compatible with the HVAC system.

35. The replaceable filter assembly of claim 34, wherein the notification comprises an audible signal.

36. The replaceable filter assembly of claim 35, wherein the audible signal advises the user of a correct replaceable filter assembly model number for the HVAC system.

37. The replaceable filter assembly of claim 34, wherein the notification comprises a visual signal.

38. The replaceable filter assembly of claim 37, wherein the visual signal advises the user of a correct replaceable filter assembly model number for the HVAC system.

39. A method for controlling a system that receives a replaceable media assembly, the system having a controller, the method comprising:
providing a replaceable media assembly that includes a replaceable media component and a storage means for storing information;
providing a communication channel between the storage means of the replaceable media assembly and the controller of the system; and
passing selected information from the storage means to the controller of the system.

40. A method according to claim 39, wherein the replaceable media comprises a filter.

41. A method according to claim 39, wherein the replaceable media comprises a filter and the system comprises an HVAC system.

42. A method according to claim 39, wherein the replaceable media comprises a brake pad.

43. A method according to claim 39, wherein the replaceable media comprises a brake pad and the system comprises a braking system.

44. A method according to claim 39 wherein the storage means comprises a memory.

45. A method according to claim 39 wherein the storage means comprises a programmed micro-controller.

46. A method of upgrading a program of a controller of a system that receives a replaceable media assembly, the method comprising:
providing a replaceable media assembly including a storage means;
electrically coupling the storage means to the controller of the system when the system receives the replaceable media assembly; and
transferring a program from the storage means of the replaceable media assembly to the controller of the system.

47. A method according to claim 46, wherein the replaceable media comprises a filter.

48. A method according to claim 46, wherein the replaceable media comprises a filter and the system comprises an HVAC system.

49. A method according to claim 46, wherein the replaceable media comprises a brake pad.

50. A method according to claim 46, wherein the replaceable media comprises a brake pad and the system comprises a braking system.

51. A method according to claim 46, wherein the storage means comprises a memory.

52. A method according to claim 46, wherein the storage means comprises a programmed micro-controller.
